(19) United States
(12) Patent Application Publication
(10) Pub. No.: US 2022/0398681 A1
(43) Pub. Date: Dec. 15, 2022

(54) SYSTEM FOR SENDING TOPIC-SPECIFIC DIGITAL MESSAGES

(71) Applicants: Christopher Howe, Sherwood, OR (US); Samantha Howe, Sherwood, OR (US)

(72) Inventors: Christopher Howe, Sherwood, OR (US); Samantha Howe, Sherwood, OR (US)

(21) Appl. No.: 17/839,334

(22) Filed: Jun. 13, 2022

Related U.S. Application Data
(60) Provisional application No. 63/209,776, filed on Jun. 11, 2021.

(51) Int. Cl. G06Q 50/20

(52) U.S. Cl. CPC G06Q 50/20

(57) ABSTRACT

A system for sending topic-specific digital messages from professionals to their clients with information that is more relevant and applicable to the needs of the recipients based upon prior interactions with the professional.

### CROSS REFERENCE TO RELATED APPLICATIONS

This application claims priority to copending U.S. Application Ser. No. 63/209,776 filed on Jun. 11, 2021 which is hereby incorporated by reference for all purposes.

### BACKGROUND

The message sending system addresses the problems that most professionals (trainers, coaches, therapists) have when they need to provide their clients with some sort of follow-up after their training session. The most convenient way is through e-mail, hut it is exhaustively time-consuming to follow-up after each session and ensure the student has the tools they need to succeed. In the professional instruction space, the current available solutions to the problem of sending follow up e-mails to an instructional session are either incredibly time-intensive, or impersonal, and rarely contain only the relevant information. Most professionals simply choose not to follow up with clients at all. This limits the ability of the client to adopt the material presented in an effective and timely fashion. There currently exists no way of simply and effectively sending mass customized e-mail to clients. Every other method is time-consuming, partially irrelevant, or impersonal.

The message sending system can operate at a speed which permits sending follow-up information up to a 20-fold improvement. The relevance of the information the client receives also improves drastically from conventional methods. The message sending system takes stores of data defined by the professional, and send the client access to these stores of data. The key is the simple survey-style interface used by the professional. The benefits of the message sending system are: An 83% reduction in time spent on sending follow up resources. Reduced clutter from unnecessary session components. Improved consistency for each client going through the professional's program. The system differs from what currently exists. This message sending system improves the ability to tailor content sent to clients in ways that is currently not possible. Each client gets exactly the information they need, no more, no less.

While there are other less efficient systems in the current art that can send e-mails to contacts generally, they do not allow for customizations of topics that efficiently target the expected recipients. The message sending system allows for mass customization in format and topic through a simple form that creates a way to send topical and useful information quickly and effectively.

### BRIEF SUMMARY

Embodiments of the present disclosure may include a system for sending topic-specific digital messages from professionals to their clients transmitted via a network of computer systems, including the elements of a professional informational interface. Embodiments may also include topical data store. Embodiments may also include informational keys. Embodiments may also include a client database. Embodiments may also include a digital message sending program.

In some embodiments, the system for sending topic-specific digital messages from professionals to their clients transmitted via a network of computer systems, where the professional informational interface may include a computer monitor, an input device, and a software application. In some embodiments, the system for sending topic-specific digital messages from professionals to their clients transmitted via a network of computer systems, where the professional information interface displays the names of topics covered in a professional instruction presentation to professional clients,

In some embodiments, the system for sending topic-specific digital messages from professionals to their clients transmitted via a network of computer systems, where the topical data store may include the names of topics and associated narratives of the names of topics covered in a professional instruction presentation. In some embodiments, the system for sending topic-specific digital messages from professionals to their clients transmitted via a network of computer systems, where the informational keys may be pre-defined search terms of the names of topics displayed on the professional informational interface presented in the professional instruction presentation.

In some embodiments, the system for sending topic-specific digital messages from professionals to their clients transmitted via a network of computer systems, where the digital addresses may be personally identifiable addresses including of at least one e-mail address, direct messaging usernames, and cellular phone numbers. In some embodiments, the system for sending topic-specific digital messages from professionals to their clients transmitted via a network of computer systems, where the client database may include digital addresses of professional clients attending the professional instruction presentation.

In some embodiments, the system for sending topic-specific digital messages from professionals to their clients transmitted via a network of computer systems, where the digital messages contain selectable links directing a recipient's digital device to display matching one or more narratives from the topical data store. In some embodiments, the system for sending topic-specific digital messages from professionals to their clients transmitted via a network of computer systems, where the digital message sending program may include a computer application, a computer server, and a computer network.

Embodiments of the present disclosure may also include a method ter sending topic-specific digital messages from professionals to their clients transmitted via a network of computer systems, including the elements of receiving narratives from a professional that may be collected in a topical data store. Embodiments may also include associating names of topics with the narratives collected in the topical data store.

Embodiments may also include storing the narratives and names of topics in the topical data store. Embodiments may also include creating informational keys linking the names of topics with at least one narrative in the topical data store. Embodiments may also include Searching the contents of the topical data store by entering at least one informational key using a professional informational interface.

Embodiments may also include displaying a matching result from the search conducted in the topical data store. Embodiments may also include correlating the matching result to a professional client's digital address. Embodiments may also include generating a digital message addressed to the professional client including selectable links to the matching result as contained within the topical data store. Embodiments may also include sending a digital message to the professional client that contains selectable links directing a. professional client's digital device to display matching one or more narratives from the topical data store.

In some embodiments, the topical data store may be accessed by a computer network connection to the professional informational interface. In some embodiments, the narratives may include written, aural, and video material presented by the professional. In some embodiments, the informational keys may include a short alphanumeric sort-type within the topical data store.

In some embodiments, the names of topics may include abstracted language of the narratives presented by the professional. In some embodiments, the matching result may be sent to a mobile application. In some embodiments, the matching result may be sent to a web site. In some embodiments, the matching result may he sent to a desktop computer application. In some embodiments, the digital address may include e-mail address, direct messaging username, or cellular phone number.

### BRIEF DESCRIPTION OF THE FIGURES

FIG. 1 is a block diagram illustrating a system, according to some embodiments of the present disclosure.

FIG. 2 is a block diagram further illustrating the system from FIG. 1, according to some embodiments of the present disclosure.

FIG. 3 is a block diagram further illustrating the system from FIG. 1, according to some embodiments of the present disclosure.

FIG. 4 is a block diagram further illustrating the system from FIG. 1, according to some embodiments of the present disclosure.

FIG. 5A is a flowchart illustrating a method for sending topic-specific digital messages, according to some embodiments of the present disclosure.

FIG. 5B is a flowchart extending from FIG. 5A and further illustrating the method for sending topic-specific digital messages, according to some embodiments of the present disclosure.

### DETAILED DESCRIPTION

In order to set up this message sending system, there needs to be a program which records simple input from a user, an e-mail sending program, a publicly accessible file storage program, and a connective program. The record generation program can be anything which allows a user to offer simple, non-variable inputs. Once the record is generated, the connective program will need to translate the outputs into a format readable by the e-mail program. The e-mail program must be robust enough to allow for the keys contained in the record to control whether any given segment of the e-mail is included in what is sent. The e-mail segments each contain a link to the publicly accessible file storage system, but not the whole thing. The links only go to the subsection of the file storage system containing relevant information to the keyed topic.

The critical elements are the professional interface (1), the e-mail sender (3) and the information key (4). With just these three elements the mass customized e-mail function would exist. However, the additional use of an information collection is a substantial reason of why the message sending system is useful. The message sending system's efficiency could be enhanced by adding an access control element to the information collection. The components in this message sending system could be theoretically structured to function in the reverse direction. Instead of using the professional as the input selector, one may use an end user as the input selector. An example of this functionality could be as a customer service tool to allow unskilled call center employees to respond quickly and accurately to self-selected issues from customers. Such a call center employee would immediately have all tools available to help troubleshoot the issue the customer may be having.

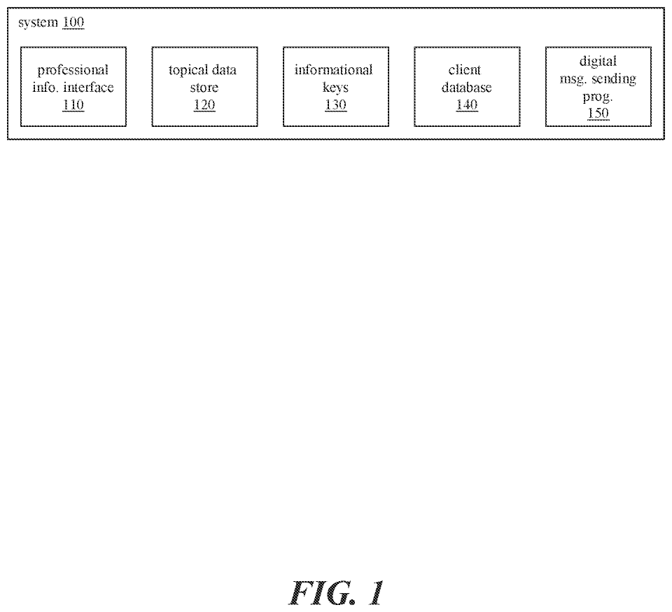

FIG. 1 is a block diagram that describes a system 100, according to some embodiments of the present disclosure. In some embodiments, the system 100 may include a professional informational interface 110, topical data store 120, informational keys 130, a client database 140, and a digital message 150 sending program. In some embodiments, where the professional information interface displays the names of topics covered in a professional instruction presentation to professional clients. In some embodiments, the system 100 for sending topic-specific digital messages from professionals to their clients transmitted via a network of computer systems, where the topical data store 120. me names of topics and associated narratives of the names of topics covered in a professional instruction presentation.

In some embodiments, where the informational keys 130 may he pre-defined search terms of the names of topics displayed on the professional informational interface 110 presented in the professional instruction presentation. In some embodiments, the system 100 for sending topic-specific digital messages from professionals to their clients transmitted via a network of computer systems, where the digital addresses may be personally identifiable addresses. Of at least one e-mail address, direct messaging usernames, and cellular phone numbers.

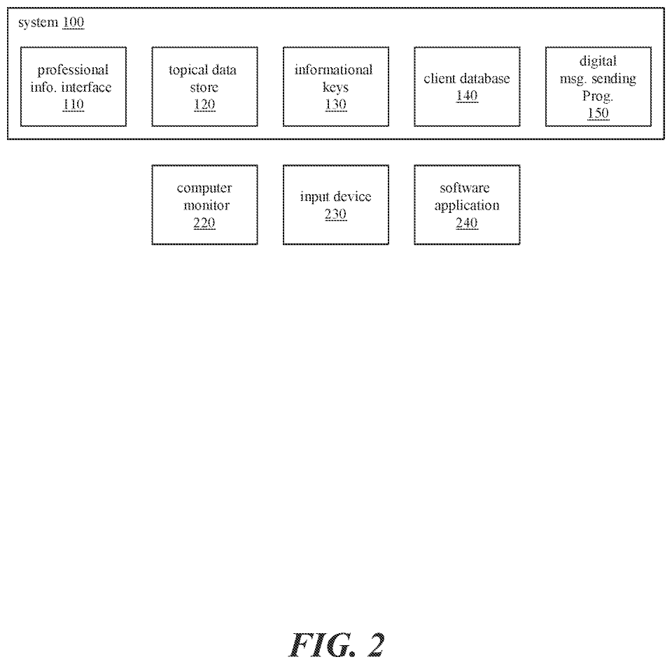

FIG. 2 is a block diagram that further describes the system 100 from FIG. 1, according to some embodiments of the present disclosure. In some embodiments, the system 100 for sending topic-specific digital messages from professionals to their clients transmitted via a network of computer systems, where the professional informational interface 110.

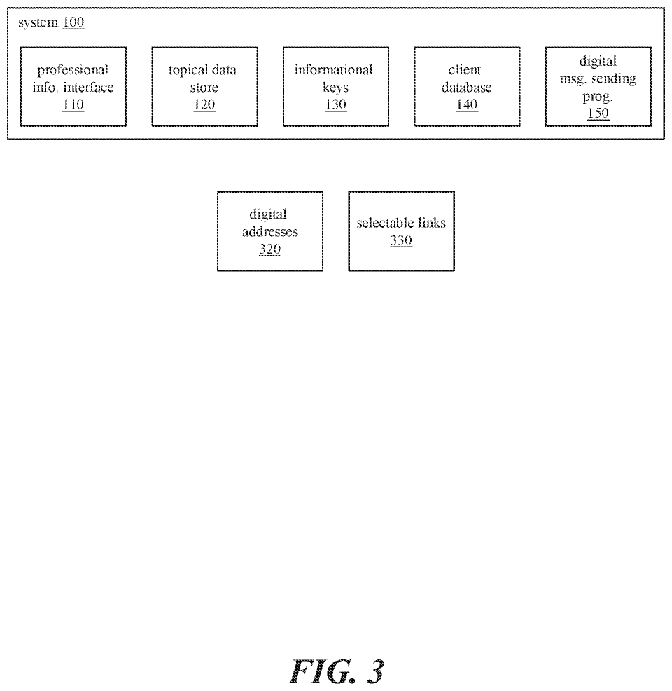

FIG. 3 is a block diagram that further describes the system 100 from FIG. 1, according to some embodiments of the present disclosure. In some embodiments, the system 100 for sending topic-specific digital messages from professionals to their clients transmitted via a network of computer systems, where the client database 140. In some embodiments, the system 100 for sending topic-specific digital messages from professionals to their clients transmitted via a network of computer systems, where the digital messages.

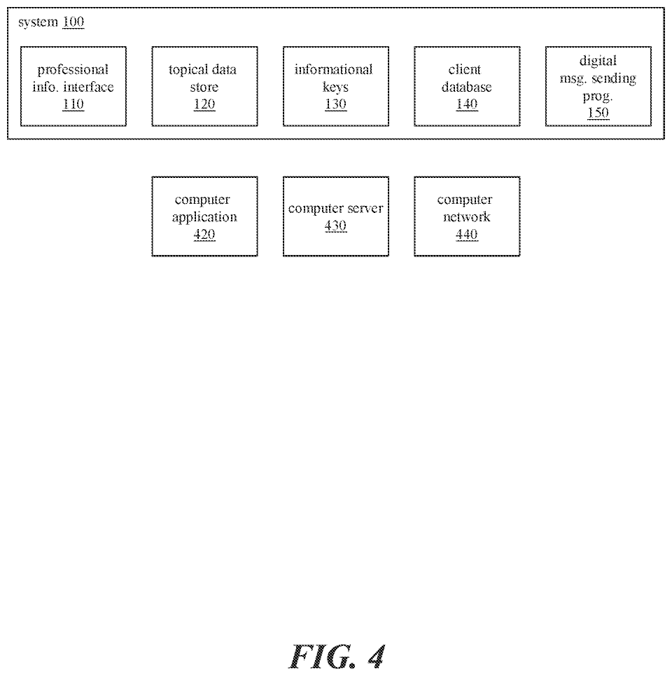

FIG. 4 is a block diagram that further describes the system 100 from FIG. 1, according to some embodiments of the present disclosure. In some embodiments, the system 100 for sending topic-specific digital messages from professionals to their clients transmitted via a network of computer systems, where the digital message 150 sending program.

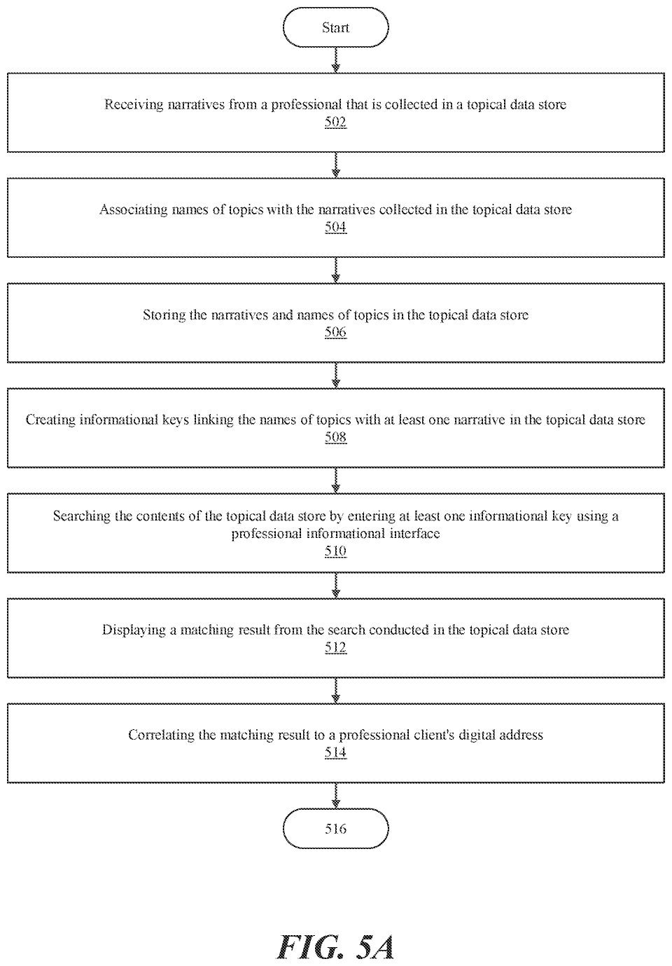

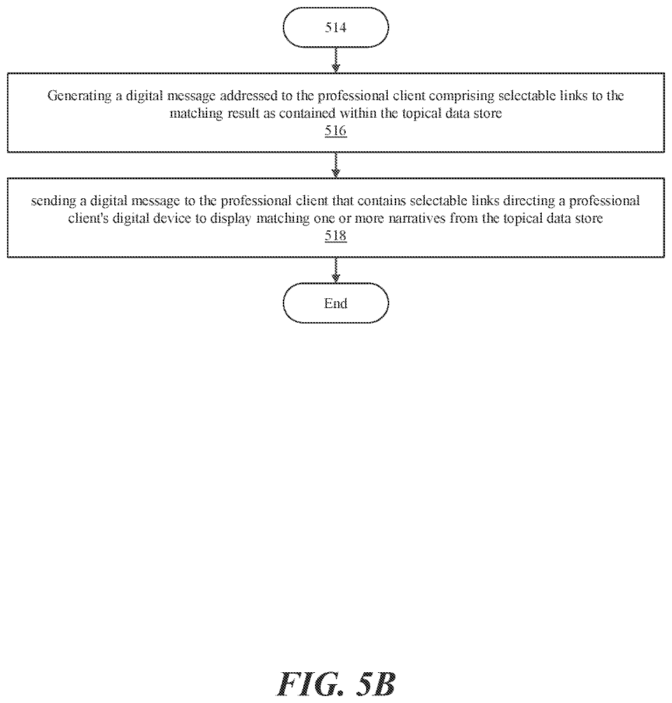

FIGS. 5A to 5B are flowcharts that describe a method for sending topic-specific digital messages, according to some embodiments of the present disclosure. In some embodiments, at 502, the method may include receiving narratives from a professional that may be collected in a topical data store. At 504, the method may include associating names of topics with the narratives collected in the topical data store. At 506, the method may include storing the narratives and names of topics in the topical data store. At 508, the method may include creating informational keys linking the names of topics with at least one narrative in the topical data. store.

In some embodiments, at 510, the method may include Searching the contents of the topical data store by entering at least one informational key using a professional informational interface. At 512, the method may include displaying a matching result from the search conducted in the topical data store. At 514, the method may include correlating the matching result to a professional client's digital address. At 516, the method may include generating a digital message addressed to the professional client comprising selectable links to the matching result as contained within the topical data store. At 518, the method may include sending a digital message to the professional client that contains selectable links directing a professional client's digital device to display matching one or more narratives from the topical data store. The elements of, the method may include 502 to 518.

In some embodiments, the topical data store may be accessed by a computer network connection to the professional informational interface. In some embodiments, the narratives comprise written, aural, and video material presented by the professional. In some embodiments, the informational keys may comprise a short alphanumeric sort-type within the topical data store. In some embodiments, the names of topics comprise abstracted language of the narratives presented by the professional. In some embodiments, the matching result may be sent to a mobile application. In some embodiments, the matching result may be sent to a web site. In some embodiments, the matching result may be sent to a desktop computer application. In sonie embodiments, the digital address may comprise e-mail address, direct messaging username, or cellular phone number.

1. A system for sending topic-specific digital messages from professionals to their clients transmitted via a network of computer systems, comprising the elements of:
(a) a professional informational interface;
(b) topical data store;
(c) informational keys;
(d) a client database; and
(e) a digital message sending program.

2. The system for sending topic-specific digital messages from professionals to their clients transmitted via a network of computer systems of claim 1, where the professional informational interface comprises a computer monitor, an input device, and a software application.

3. The system for sending topic-specific digital messages from professionals to their clients transmitted via a network of computer systems of claim 2, where the professional information interface displays the names of topics covered in a professional instruction presentation to professional clients.

4. The system for sending topic-specific digital messages from professionals to their clients transmitted via a network of computer systems of claim 2, where the topical data store comprises the names of topics and associated narratives of said names of topics covered in a professional instruction presentation.

5. The system for sending topic-specific digital messages from professionals to their clients transmitted via a network of computer systems of claim 2, where the informational keys are pre-defined search terms of said names of topics displayed on the professional informational interface presented in the professional instruction presentation.

6. The system for sending topic-specific digital messages from professionals to their clients transmitted via a network of computer systems of claim 2, where the client database comprises digital addresses of professional clients attending said professional instruction presentation.

7. The system for sending topic-specific digital messages from professionals to their clients transmitted via a network of computer systems of claim 5, where the digital addresses are personally identifiable addresses comprising of at least one e-mail address, direct messaging usernames, and cellular phone numbers.

8. The system for sending topic-specific digital messages from professionals to their clients transmitted via a network of computer systems of claim 6, where the digital messages contain selectable links directing a recipient's digital device to display matching one or more narratives from the topical data store.

9. The system for sending topic-specific digital messages from professionals to their clients transmitted via a network of computer systems of claim 1, where the digital message sending program comprises a computer application, a computer server, and a computer network.

10. A method for sending topic-specific digital messages from professionals to their clients transmitted via a network of computer systems, comprising the elements of:
(a) receiving narratives from a professional that is collected in a topical data store;
(b) associating names of topics with the narratives collected in the topical data store;
(c) storing the narratives and names of topics in said topical data store;
(d) creating informational keys linking the names of topics with at least one narrative in said topical data store;
(e) Searching the contents of the topical data store by entering at least one informational key using a professional informational interface;
(f) displaying a matching result from the search conducted in the topical data store;
(g) correlating said matching result to a professional client's digital address;
(h) generating a digital message addressed to the professional client comprising selectable links to the matching result as contained within the topical data store; and
(h) sending a digital message to the professional client that contains selectable links directing a professional client's digital device to display matching one or more narratives from the topical data store.

11. The method of claim 10 wherein the topical data store is accessed by a computer network connection to the professional informational interface.

12. The method of claim 10 wherein the narratives comprises written, aural, and video material presented by the professional.

13. The method of claim 10 wherein the informational keys comprises a short alphanumeric sort-type within the topical data store.

14. The method of claim 10 wherein the names of topics comprises abstracted language of said narratives presented by the professional.

15. The method of claim 10 wherein the matching result is sent to a mobile application.

16. The method of claim 10 wherein the matching result is sent to a web site.

17. The method of claim 10 wherein the matching result is sent to a desktop computer application.

18. The method of claim 10 wherein the digital address comprises e-mail address, direct messaging username, or cellular phone number.
